(19) United States
(12) Patent Application Publication
(10) Pub. No.: US 2015/0354696 A1
(43) Pub. Date: Dec. 10, 2015

(54) SHIFTING DEVICE FOR AN AUTOMATIC GEARBOX

(71) Applicant: ECS ENGINEERED CONTROL SYSTEMS, St. Gallen (CH)

(72) Inventor: Heiko SCHIRMER, Regesbostel (DE)

(73) Assignee: ECS ENGINEERED CONTROL SYSTEMS AG, St. Gallen (CH)

(21) Appl. No.: 14/761,351

(22) PCT Filed: Jan. 14, 2014
(86) PCT No.: PCT/EP2014/050567

§ 371 Date: Jul. 16, 2015

(30) Foreign Application Priority Data
Jan. 23, 2013 (DE) 10 2013 100 667.1

(51) Int. Cl. F16H 59/02; F16H 61/36

(52) U.S. Cl. CPC F16H 59/0204; F16H 61/36

(57) ABSTRACT

The invention relates to a shifting device for a transmission, especially an automatic transmission of a motor vehicle, having an actuating lever that can be moved into different positions in order to select gears, and having a movably mounted transmission component that serves to transmit movements of the actuating lever to at least one additional component, especially a control cable, whereby the actuating lever can be either coupled to or uncoupled from the transmission component. The shifting device is characterized in that, in order to effectuate the coupling, a projection of the actuating lever engages into a receptacle that is movably mounted on and/or in the transmission component. Alternatively or additionally, the shifting device is characterized in that, in order to effectuate the coupling, a projection of the transmission component engages into a receptacle that is movably mounted on and/or in the actuating lever.

### CROSS-REFERENCE TO RELATED APPLICATIONS

This application is a national stage application (under 35 USC §371) of PCT/EP20141050567, filed Jan. 14, 2014, which claims benefit of German application No. 10 2013 100 667.1, filed Jan. 23, 2013.

### BACKGROUND OF THE INVENTION

### Technical Field and State of the Art

The invention relates to a shifting device for an automatic transmission of a motor vehicle, comprising an actuating lever that can be moved into different positions in order to select gears, and comprising a movably mounted transmission component that serves to transmit movements of the actuating lever to at least another component, especially to a control cable, whereby the actuating lever can be either coupled to or uncoupled from the transmission component.

A device of this type is described in German patent application DE 10 2012 106 544 A1.

Another shifting device is described in German patent application DE 100 63 604 A1. Here, a bolt is configured so that it can be moved by a projection that is configured as a push rod. This bolt is pushed down by means of the push rod so that a cable block is disconnected from a lever housing of the shifting device in the automatic mode, whereby the bolt is provided with a return spring that, in the manual mode, returns the bolt to its original position so as to couple the cable block to the lever housing.

Another shifting device is disclosed in German patent application DE 102 52 009 A1. This document describes a shift carriage which is mounted so as to be linearly movable in a plane and which is configured such that, since the force is coupled, the movement of a control lever in a first shifting gate effectuates a linear movement of the shift carriage, whereas a movement of the control lever in a second shifting gate effectuates a decoupling of the movement of the control lever from the shift carriage.

### SUMMARY OF THE INVENTION

It is an objective of the present invention to put forward a device of this type which allows a reliable coupling of the actuating lever to the transmission component as well as a reliable decoupling, and which is also very resistant to wear and tear.

This objective is achieved by a shifting device that is characterized in that,
a) in order to effectuate the coupling, a projection of the actuating lever engages into a receptacle that is movably mounted on or in the transmission component, or in that,
b) in order to effectuate the coupling, a projection of the transmission component engages into a receptacle that is movably mounted on or in the actuating lever.

The shifting device according to the invention has the special advantage that, since the receptacle is movably mounted, the coupling can be achieved even if the actuating lever is not situated exactly in the position intended for the coupling.

The shifting device according to the invention also has the very special advantage that is hardly prone to any wear and tear of the components that engage with each other during the coupling since the movable mounting of the receptacle makes it possible to avoid the occurrence of forces that could damage, for instance, the edge of the receptacle or parts of the projection.

In a particularly advantageous embodiment, the receptacle is mounted so as to be movable against the force of a spring element which can be, for example, a leaf spring. If the actuating lever has the projection, the receptacle is preferably secured on and/or in the transmission component so as to be movable against the force of the spring element. As an alternative, it can conversely also be provided for the transmission component to have the projection and for the receptacle to be arranged on and/or in the actuating lever so as to be movable against the force of the spring element. In the former case, it is preferably provided that the spring element acts directly between the transmission component and the receptacle. In the latter case, in contrast, it is preferably provided that the spring element acts directly between the actuating lever and the receptacle.

As already mentioned, it can be advantageously provided for the spring element to have a leaf spring or to be configured as a leaf spring. Advantageously, such a configuration can be especially compact. However, it is also possible to employ spring elements of a different type.

In an especially advantageous embodiment, it is provided that the receptacle is configured so that it can move, especially linearly, in a recess of the actuating lever or of the transmission component. In particular, it can be advantageously provided for the actuating lever to have a recess in which the receptacle is arranged so that it can move linearly along the direction in which the projection can be inserted into the receptacle. Alternatively, it can be provided that the transmission component has the recess in which the receptacle is arranged so that it can move linearly along the direction in which the projection of the actuating lever can be inserted.

In particular, the receptacle can be configured like a container and can have an opening through which the projection can be inserted. As an alternative or in addition, it can be provided for the receptacle to have a rigid sleeve that surrounds at least part of the projection when in the coupled position.

Preferably, it is provided for the projection to be accommodated in the receptacle without play when in the coupled position. This can effectively prevent disturbing rattling noises as well as any unnecessary movements of the actuating lever when in the coupled position.

Especially in order to make it easier to attain the coupled position, it can be advantageously provided for the cavity of the receptacle to taper, starting from an opening through which the projection can be inserted, and/or for the receptacle to be configured so as to be conical on the inside. In particular, as an alternative or in addition, it can be provided for the projection to taper towards its free end and/or for the projection to be configured so as to be conical.

Preferably, the receptacle and the projection have mating tapered sections and/or conical sections in order to ensure a positive fit without play.

It can be advantageously provided for the actuating lever and/or the transmission component to be mounted in a shifting frame so as to be movable, especially rotatable or pivotable, and/or for the actuating lever and the transmission component to be mounted in a shifting frame so as to be rotatable or pivotable around a shared pivoting axis.

In a special embodiment, the actuating lever can be moved, especially pivoted, either into a first shifting gate or into a second, preferably parallel, shifting gate. In the first shifting gate, the actuating lever is preferably mechanically coupled to the transmission component in such a way that, when the actuating lever is pivoted into the first shifting gate, the transmission component is moved along in the same manner, in particular, the transmission component is pivoted along with the actuating lever. In the second shifting gate, the actuating lever is preferably not coupled to the transmission component, so that it can be pivoted into the second shifting gate without the transmission component following its movements. In the uncoupled position, it can especially be provided for the transmission component to be secured in its position by a locking means until the actuating lever has once again been coupled to the transmission component.

In an advantageous manner, it can be provided for the coupling or decoupling to take place by pivoting the actuating lever in a pivoting direction perpendicular to the directions of the shifting gate.

A transmission is particularly advantageous, especially an automatic transmission, or a motor vehicle with a shifting device according to the invention.

Additional objectives, advantages, features and application possibilities of the present invention ensue from the description below of an embodiment with reference to the drawing. In this context, all of the described and/or depicted features, either on their own or in any meaningful combination, constitute the subject matter of the present invention, also irrespective of their compilation in the claims or the claims to which they refer back.

### DESCRIPTION OF THE DRAWINGS

The following is shown:

FIG. 1 an embodiment of a shifting device according to the invention, in the uncoupled position,

FIG. 2 the embodiment in a cross-sectional view, as seen in the direction of the free end of the actuating lever,

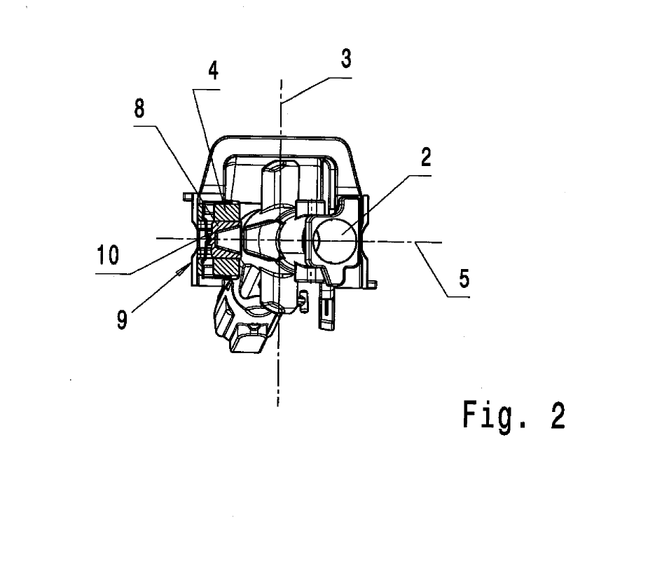

FIG. 3 a perspective view of the shifting device according to the embodiment in the coupled position, and

FIG. 4 the embodiment in the coupled position, in a cross-sectional view, as seen in the direction of the free end of the actuating lever.

### DETAILED DESCRIPTION OF THE INVENTION

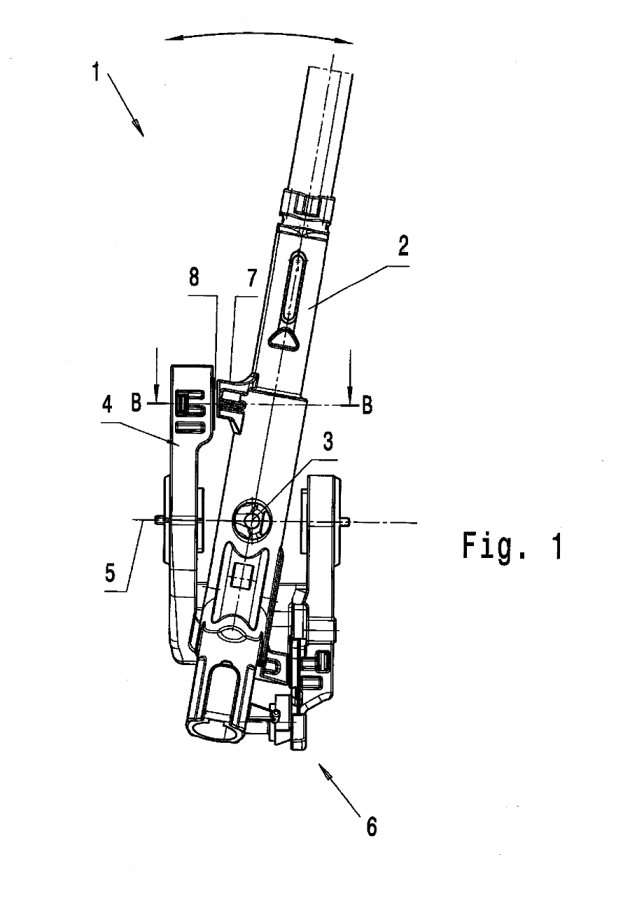

FIG. 1 shows a shifting device 1 having an actuating lever 2 that can be moved into different positions in order to select gears. Concretely speaking, the actuating lever is mounted so as to be pivotable either into a first shifting gate or into a second shifting gate in that it is pivoted around a first rotational axis 3.

The shifting device also has a transmission component 4 to transmit movements of the actuating lever 2 to at least one other component (not shown here). The transmission component 4 is mounted so as to be pivotable around a second axis 5. A coupling mechanism 6 that serves to couple a control cable is provided at the lower end of the transmission component 4.

In the position shown, the actuating lever is uncoupled from the transmission component and it can be pivoted around the second axis 5 in order to shift up or down, without the transmission component 4 moving along with the actuating lever.

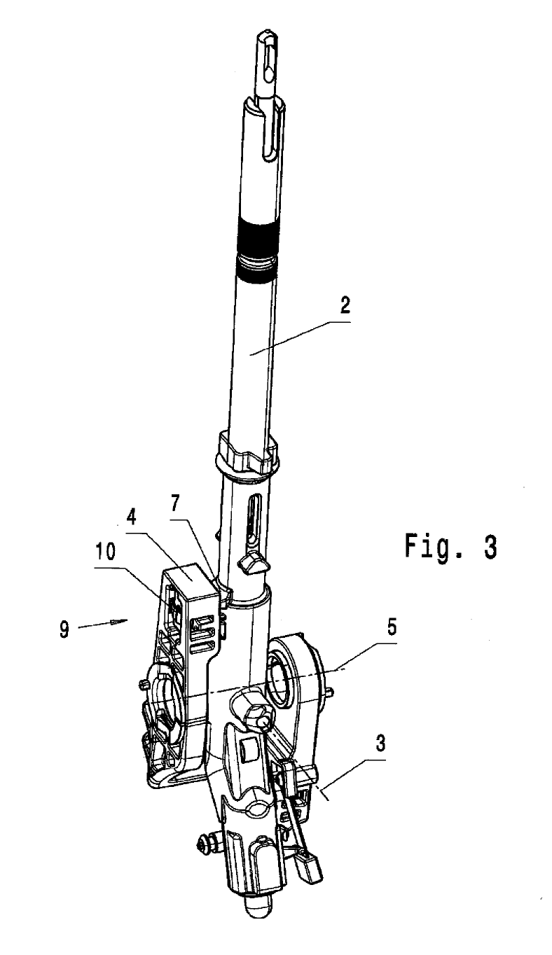

In order to effectuate the coupling, the actuating lever 2 is pivoted around the first axis 3, as a result of which a projection 7 engages into a recess 8 of the transmission component. The coupled position is shown in FIG. 3.

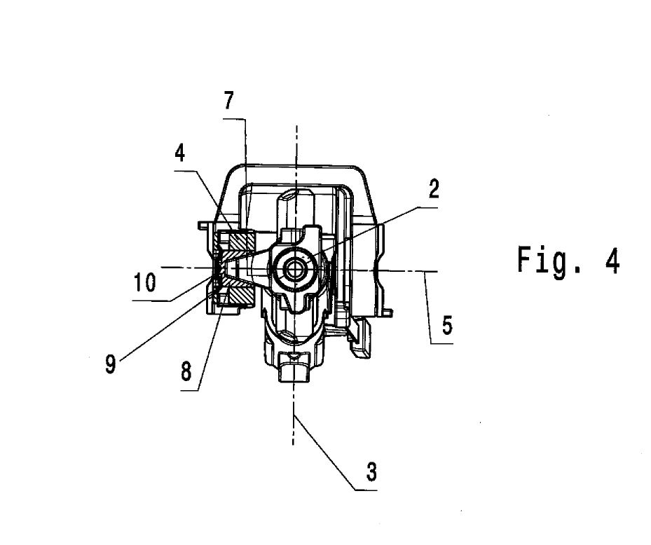

FIG. 4 shows the shifting device in a cross-sectional view, as seen in the direction of the free end of the actuating lever 2.

It can be seen that the receptacle 8 is mounted in a recess 9 of the transmission component 4 so as be movable against the force of a leaf spring 10. It can also be seen that the projection 7 tapers towards its free end and that the inner walls of the recess 9 likewise surround a tapering space into which the projection 7 engages with a positive fit when in the coupled position.

### LIST OF REFERENCE NUMERALS

1 shifting device
2 actuating lever
3 first axis
4 transmission component
5 second axis
6 coupling mechanism
7 projection
8 receptacle
9 recess
10 leaf spring

1. A shifting device for an automatic transmission of a motor vehicle, comprising:
an actuating lever adapted to be moved into different positions in order to select gears;
a projection extending from a surface of the actuating lever; and
a movably mounted transmission component that serves to transmit movements of the actuating lever to at least another component, such as a control cable;
wherein the actuating lever is adapted to be either coupled to or uncoupled from the transmission component; and
in order to effectuate the coupling, the projection of the actuating lever engages into a receptacle that is movably mounted on or in the transmission component.

2. The shifting device according to claim 1, wherein the receptacle is mounted so as to be movable against the force of a spring element relative to the actuating lever or relative to the transmission component.

3. The shifting device according to claim 2, wherein the spring element has a leaf spring.

4. The shifting device according to claim 1 wherein
the transmission component has a recess in which the receptacle is arranged so that it can move linearly along the direction in which the projection can be inserted.

5. The shifting device according to claim 4 wherein
the receptacle has a rigid sleeve that surrounds at least part of the projection when in the coupled position.

6. The shifting device according to claim 4 wherein
a cavity of the receptacle tapers, starting from an opening through which the projection can be inserted.

7. The shifting device according to claim 6 wherein the projection tapers towards its free end or is conical.

8. The shifting device according to claim 1 further comprising:
a shifting frame, wherein
the actuating lever and the transmission component are mounted in the shifting frame so as to be rotatable or pivotable around a shared pivoting axis.

9. The shifting device according to claim 1 wherein the actuating lever is configured to move or be pivoted either into a first shifting gate in which it is coupled to the transmission component, into a second shifting gate in which it is not coupled to the transmission component.

10. An automatic transmission with a shifting device according to claim 1.

11. A motor vehicle with a shifting device according to claim 1.

12. A shifting device for an automatic transmission of a motor vehicle, comprising:
an actuating lever adapted to be moved into different positions in order to select gears;
a movably mounted transmission component that serves to transmit movements of the actuating lever to at least another component, such as a control cable; and
a projection extending from a surface of the transmission component;
wherein the actuating lever is adapted to be either coupled to or uncoupled from the transmission component; and
in order to effectuate the coupling, the projection of the transmission component engages into a receptacle that is movably mounted on or in the actuating lever.

13. The shifting device according to claim 12 wherein the actuating lever has a recess in which the receptacle can move linearly along the direction in which the projection can be inserted.

14. The shifting device according to claim 13 wherein the receptacle has a rigid sleeve that surrounds at least part of the projection when in the coupled position.

15. The shifting device according to claim 13 wherein a cavity of the receptacle tapers, starting from an opening through which the projection can be inserted.

16. The shifting device according to claim 15 wherein the projection tapers towards its free end or is conical.

17. The shifting device according to claim 12 further comprising:
a shifting frame, wherein the actuating lever and the transmission component are mounted in the shifting frame so as to be rotatable or pivotable around a shared pivoting axis.

18. An automatic transmission with a shifting device according to claim 12.

19. A motor vehicle with a shifting device according to claim 12.
